(19) United States
(12) Patent Application Publication
(10) Pub. No.: US 2019/0022737 A1
(43) Pub. Date: Jan. 24, 2019

(54) FRICTION STIR BLIND RIVET JOINING SYSTEM AND METHOD

(71) Applicants: GM GLOBAL TECHNOLOGY OPERATIONS LLC, Detroit, MI (US); SHANGHAI JIAO TONG UNIVERSITY, SHANGHAI (CN)

(72) Inventors: Yunwu Ma, Shanghai (CN); Yongbing Li, Shanghai (CN); Blair E. Carlson, Ann Arbor, MI (US); Zhongqin Lin, Shanghai (CN)

(73) Assignees: GM GLOBAL TECHNOLOGY OPERATIONS LLC, Detroit, MI (US); SHANGHAI JIAO TONG UNIVERSITY, SHANGHAI (CN)

(21) Appl. No.: 15/654,295

(22) Filed: Jul. 19, 2017

(51) Int. Cl. B21J 15/02; B21J 15/04; B21J 15/12; B21J 15/36; F16B 19/10

(52) U.S. Cl. CPC B21J 15/027; B21J 15/045; F16B 19/1054; B21J 15/365; B21J 15/12

(57) ABSTRACT

Friction stir blind rivet systems and methods are provided for joining workpieces. A FSBR joining system includes a mandrel with a head forming a tip. A stem extends from the head and has a narrowed section forming a notch. A tail section of the mandrel is configured to break off at the notch forming a broken end. A shank also has a head and a body, with a through-hole defined through the shank. The shank head includes a shoulder forming a surface contacting one workpiece. The head has an outermost point opposite the surface. A range is defined between the outermost point of the head and the surface. A wall projects from another workpiece and is formed around the body. The wall has a size formed by the mandrel and that is controlled to enable the body to deform.

### INTRODUCTION

The present disclosure generally relates to rivet systems and methods, and more particularly relates to friction stir blind rivet (FSBR) systems and methods.

Manufactured products are typically assembled from a number of elements that are integrated into a product. The individual elements may be engaged in a variety of fashions, one of which involves being joined together. The options for joining elements together are copious. However, the challenges in joining parts of an assembly, and in joining different types of materials are boundless, and so the need persists for new and effective products and methods of joining.

FSBR is a joining process where a blind rivet rotating at high speed is brought into contact with a workpiece. Force and frictional heat displaces workpiece material as the rivet is driven into the workpiece. After the rivet is inserted, the mandrel is broken and a shank fastens the workpieces together. While FSBR is a suitable joining process for many applications, for certain aspects and applications improvements to further advance the technology may be beneficial.

Accordingly, it is desirable to provide new systems and methods for joining components using FSBR. Furthermore, other desirable features and characteristics of the present disclosure will become apparent from the subsequent detailed description and the appended claims, taken in conjunction with the accompanying drawings and the foregoing technical field and background.

### SUMMARY

FSBR systems and method are provided for joining workpieces. In a number of examples, a FSBR joining system includes a mandrel that has a head forming a tip, with a stem extending from the head. The stem has a narrowed section forming a notch configured so that a tail section of the mandrel may be broken off, wherein the mandrel extends from the tip to a broken end. A shank also has a head and an extending body, with a through-hole defined through the shank. The shank head includes a shoulder forming a surface that contacts one workpiece, and the head has an outermost point opposite the surface. A range is defined between the outermost point of the head and the surface. A wall projects from another workpiece and is formed around the body. The wall has a size formed by the mandrel and that is controlled to enable the body to deform.

In another example, the size of the wall may be controlled by use of the equation for pseudo heat index

$$( PHI ) = \frac{{ω}^{2}}{V 10000} ,$$

where ω is rotational speed of the mandrel and V is feed rate of the mandrel.

In another example, the body of the shank may be deformed by buckling to form annular sections that bulge outward against the workpieces.

In another example, the notch may be formed a distance d_{notch} from the tip of the mandrel so that the broken end is disposed in the range.

In another example, the workpieces may have a stack thickness that varies within a grip range defined by tₘᵢₙ≤t≤tₘᵢₙ+d_{head}, where t is the stack thickness of the workpieces together, tₘᵢₙ is the minimum allowable stack thickness, and d_{head} is a second distance that is defined from the outermost point of the shank head to the surface formed by the shoulder of the shank head.

In another example, the location of the broken end of the mandrel may be disposed at a location (l_{mandrel-to-shank}) that is defined by dₚᵤₗₗ−(d_{feed}−d_{notch}), where dₚᵤₗₗ is an amount the mandrel is pulled to compress the shank, d_{feed} is an amount the mandrel is fed into the workpieces, and d_{notch} is a distance from the tip of the mandrel to the notch.

In another example, the wall may encircle the shank body and may rigidly retain the shank in position.

In another example, the mandrel, when extending only from the tip to the broken end, may extend completely through the workpieces.

In additional examples, a FSBR joining method includes providing a mandrel that has a tip and a notch. The mandrel extends through a shank that has a head with an outermost point and a surface opposite the outermost point. Parameters are determined that include a mandrel rotational speed (ω), a mandrel strength, and a distance d_{notch} from the tip to the notch. A machine is set to operate using the parameters and to apply the FSBR to a workpiece. The machine is operated to break a tail section from the mandrel so that the mandrel extends from the tip to a broken end, and so that the broken end is disposed within the head.

In another example, determining the parameters may include testing the mandrel rotational speed (ω) and may include testing the feed rate (V) by applying the mandrel to penetrate the workpieces and then pulling-back the mandrel to break-off its tail section. A determination may then be made as to whether deformation of the shank body has occurred such as with formation of annular sections from buckling. When the determination finds deformation has not occurred, a pseudo heat index is adjusted by decreasing the ω or increasing the V imparted by the machine.

In another example, determining the parameters may include testing the mandrel strength by subjecting the FSBR to a lap-shear test including fracture and identifying whether the mandrel has sheared. When the determination finds the mandrel has sheared, the strength of the mandrel is increased.

In another example, determining the parameters may include testing the distance d_{notch} by defining a range for acceptable locations of the broken end as between the outermost point of the shank head and the surface of the shank head against the workpiece. The distance d_{notch} may then be evaluated to determine whether the broken end is within the range by calculating l_{mandrel-to-shank}, where l_{mandrel-to-shank}=dₚᵤₗₗ−(d_{feed}−d_{notch}), dₚᵤₗₗ is a distance the mandrel is pulled to compress the shank, d_{feed} is a distance the mandrel is fed to penetrate workpieces, and d_{notch} is a distance from the tip to the notch.

In another example, when the calculation result is l_{mandrel-to-shank}<0, d_{notch} may be increased to move the broken end of the mandrel within the range.

In another example, when the calculation result is l_{mandrel-to-shank}>d_{head}, d_{notch} may be reduced to move the broken end of the mandrel within the range.

In another example, a clamp actuator clamps onto the mandrel, and a linear actuator advances the mandrel toward a workpiece. When a force sensor registers a force increase indicative of mandrel contact with the workpiece, a rotary actuator operates at the mandrel rotational speed ω, and the linear actuator advances the mandrel at the feed rate V. When the head of the shank contacts the workpiece, the linear actuator stops advancing. Displacement of the mandrel is recorded as a feed distance value d_{feed}. The linear actuator pulls back on mandrel and when a break-off of the tail section occurs, a pull-back displacement of the mandrel is recorded as a value for dₚᵤₗₗ.

In another example, following break-off of the tail section, the values for d_{feed} and dₚᵤₗₗ are used to calculate a value of l_{mandrel-to-shank}, where l_{mandrel-to-shank}=dₚᵤₗₗ−(d_{feed}−d_{notch}), and d_{notch} is a distance from the tip to the notch. A distance from the outermost point of the shank head to the surface is defined as d_{head}. Satisfactory quality is indicated when the calculation results in 0≤l_{mandrel-to-shank}≤d_{head}.

In other examples, a FSBR joining system is provided for joining workpieces. A mandrel has a head forming a tip, with a stem extending from the head. The stem has a narrowed section forming a notch configured so that a tail section of the mandrel breaks-off at the notch when exposed to a tensile load. The mandrel extends from the tip to a broken end following break-off. A shank also has a head with a body extending from the head, and has a through-hole defined through the shank. The shank head includes a shoulder forming a surface that contacts the first workpiece. The head has an outermost point opposite the surface, which is a part of the head located farthest from the first workpiece. A range is defined between the outermost point of the head and the surface as d_{head}. A wall projects from the second workpiece and is formed around the body when the mandrel and shank penetrate the workpieces. The wall has a size formed by interaction of the workpieces with the mandrel and the shank, wherein the size is controlled by a rotational speed at which the mandrel is rotated and/or a feed rate at which the mandrel is advanced. The size is controlled to enable the body to deform when the mandrel head is forced against the body by pulling on the mandrel.

In another example, the shank body may form annular sections that bulge outward as a result of deformation by buckling when the mandrel head is forced against the shank body.

In another example, the notch may be formed a distance d_{notch} from the tip, so that the broken end of the mandrel is disposed in the range, and the mandrel extends completely through both workpieces.

In another example, the mandrel may be positioned relative to the shank as defined by l_{mandrel-to-shank}, where l_{mandrel-to-shank}=dₚᵤₗₗ−(d_{feed}−d_{notch}), dₚᵤₗₗ is a distance the mandrel is pulled to compress the shank, d_{feed} is a distance the mandrel is fed to penetrate workpieces, and d_{notch} is a distance from the tip to the notch.

### BRIEF DESCRIPTION OF THE DRAWINGS

The exemplary embodiments will hereinafter be described in conjunction with the following drawing figures, wherein like numerals denote like elements, and wherein:

FIG. 1 is a cross sectional illustration of a FSBR approaching workpieces to be joined, in accordance with various embodiments;

FIG. 2 is a cross sectional illustration of the FSBR of FIG. 1, in accordance with various embodiments;

FIG. 3 is a cross sectional illustration of a FSBR, in accordance with various embodiments;

FIG. 4 is a cross sectional illustration of a FSBR, in accordance with various embodiments;

FIG. 5 is a cross sectional illustration of the FSBR of FIG. 1 penetrating the workpieces, in accordance with various embodiments;

FIG. 6 is a cross sectional illustration of break-off of the mandrel from the FSBR of FIG. 1, in accordance with various embodiments;

FIG. 7 is a cross sectional illustration of the FSBR of FIG. 1 securing the workpieces, in accordance with various embodiments;

FIG. 8 is a cross sectional illustration of an exemplary FSBR applied to workpieces, in accordance with an exemplary embodiment;

FIG. 9 is a cross sectional illustration of the FSBR of FIG. 1 applied the workpieces, in accordance with various embodiments;

FIG. 10 is a cross sectional illustration of the FSBR of FIG. 8 securing the workpieces, in accordance with the exemplary embodiment;

FIG. 11 is a cross sectional illustration of the FSBR of FIG. 9 securing the workpieces, in accordance with various embodiments;

FIG. 12 is a cross sectional illustration of the FSBR of FIG. 1, in accordance with various embodiments;

FIG. 13 is a cross sectional illustration of the FSBR of FIG. 12 securing workpieces, in accordance with various embodiments;

FIG. 14 is a cross sectional illustration of the FSBR of FIG. 12 securing the workpieces, in accordance with various embodiments;

FIG. 15 is a cross sectional illustration of the FSBR of FIG. 12 securing workpieces, in accordance with various embodiments;

FIG. 16 is a cross sectional illustration of the FSBR of FIG. 1 applied to workpieces by a machine and prior to mandrel break-off, in accordance with various embodiments;

FIG. 17 is a cross sectional illustration of the FSBR of FIG. 1 applied to workpieces by a machine and after mandrel break-off, in accordance with various embodiments;

FIG. 18 is a graphical representation of retraction force versus mandrel displacement for the FSBR of FIGS. 16 and 17, in accordance with various embodiments;

FIG. 19 is a cross sectional illustration of an exemplary FSBR applied to the workpieces and exposed to a shear load;

FIG. 20 is a cross sectional illustration of the FSBR of FIG. 1 applied to the workpieces and exposed to a shear load;

FIG. 21 is a cross sectional illustration of the FSBR of FIG. 1 applied to the workpieces and exposed to a shear load;

FIG. 22 is a graph of load versus displacement for various examples of the FSBRs of FIGS. 17 and 18; and

FIG. 23 is a flow chart of an FSBR process in accordance with various embodiments.

### DETAILED DESCRIPTION

The following detailed description is merely exemplary in nature and is not intended to limit the application or its uses. Furthermore, there is no intention to be bound by any expressed or implied theory presented in the preceding technical field, introduction, brief summary or the following detailed description.

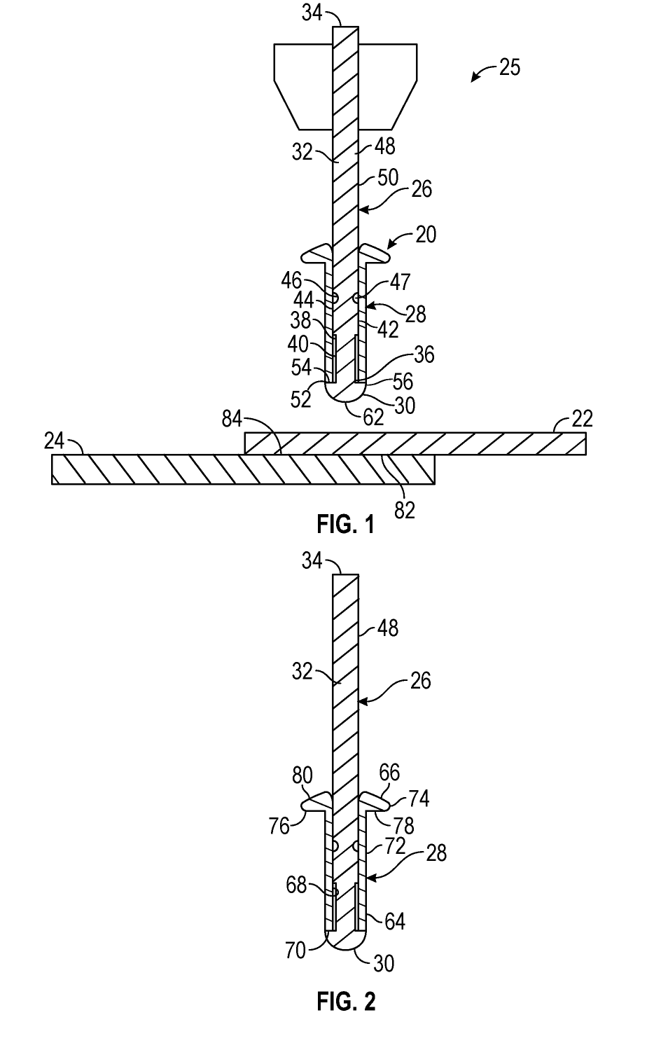

In product assembly, challenges in efficient joining of components include providing efficient processing and sufficient joint strength. In addition, the ability to ensure the quality of the joint is desirable. In accordance with the following description, a FSBR system and method provides a joint with desirable strength and efficient quality monitoring capability. With reference to FIG. 1, a FSBR 20 is provided for maintaining a fixed relative position of two or more workpieces 22, 24 via a FSBR system 25. While referred to as workpieces 22, 24, it should be noted that the FSBR system 25 is not limited to applications involving two separate parts, but is also applicable to joining any number of parts or two or more parts of a single structure. Accordingly, the term workpieces is used in reference to multiple parts to be joined, whether separated or contiguous, and regardless of the number. The workpieces 22, 24 may be any elements for which joining together is desired, and may be constructed from any suitable material. In the present example, one or both of the workpieces 22, 24 may be constructed from a light-weight material, such as an aluminum alloy or a polymeric composite material. The FSBR system 25 may be used with other materials and with workpieces of dissimilar materials. In various examples the FSBR system 25 securely joins workpieces of various materials with the aim to simplify alignment, minimize deformation and/or provide sufficient strength. The FSBR system 25 of the present example generally includes a mandrel 26 and a shank 28 cooperating to secure the workpieces 22 and 24 together. The mandrel 26 and/or the shank 28 may be fabricated of any number of materials, including but not limited to: plastic, composite, metal (e.g. aluminum alloy, stainless steel, mild steel, etc.), or metal with polymer or ceramic coating.

In various examples the mandrel 26 includes a head 30 and a stem 32 extending from the head 30 to a distal end 34. The stem 32 is an elongated element that has a proximal end 36 joining with the head 30. The stem 32 extends from the proximal end to the distal end 34. The stem 32 may have various circular or other shaped cross sections that change in size/diameter along its length. The stem 32 has a section 38 beginning at the proximal end 34 and extending partly along the stem 32 toward the distal end 34. The section 38 is solid and generally cylindrical in shape, with an outer perimeter 40 defining a diameter that is consistent along the length of the section 38. Another section 42 of the stem 32 extends from the section 38 toward the distal end 34. The section 42 has an outer perimeter 44 defining a diameter that is larger than the diameter of the section 38, consistently along its length. Adjacent the section 42 opposite the section 38, the stem 32 has a narrowed section 46 that forms a notch 47 that is annular in shape so as to have a diameter smaller than that of the sections 38 and 42, which creates a weakened point along the stem 32. A tail section 48 extends between the narrowed section 46 and the distal end 34. The tail section 48 has an outer perimeter 50 defining a consistent diameter along its length. The diameter of the tail section 48 may be the same as the diameter of the section 42.

In various examples the mandrel 26 includes the head 30, which extends radially outward from the stem 32 creating a shoulder 52 with a surface 54, which is annular in shape and faces generally in the direction of the distal end 34. The head 30 has an outer perimeter 56 defining a diameter that is larger than the diameter of the sections 38 and 42. The head 30 has a rounded shape on its leading surface 62.

With additional reference to FIG. 2, in various examples the shank 28 generally includes a body 64 and a head 66. The head 30 of the mandrel 26 may be referred to as a first head and the head 66 of the shank 28 may be referred to as a second head. The shank 28 has a through-hole 68 extending through both the body 64 and the head 66, and through which the mandrel 26 is received. The body 64 starts at an end 70 and extends to the head 66. The body 64 has an outer perimeter 72 defining a diameter that is consistent along its length from the end 70 to the head 66, defining a cylindrically shaped body 64 in the form of a hollow cylinder. The head 66 has a generally annular shape with an outer perimeter 74 defining a diameter that is larger than the outer diameter of the body 64. The head 66 forms a shoulder 76 with an annular surface 78 facing toward the end 70. The opposite surface 80 of the head 66 is generally rounded in shape. The mandrel 26 is received through the through-hole 68 so that the end 70 of the body 64 may engage the annular surface 54 of the mandrel 26 at the shoulder 52. When so disposed, the section 38, the section 42 and the notch 47 are positioned completely within the through-hole 68, while the tail section 48 extends partly into the through-hole 68 and extends outward therefrom.

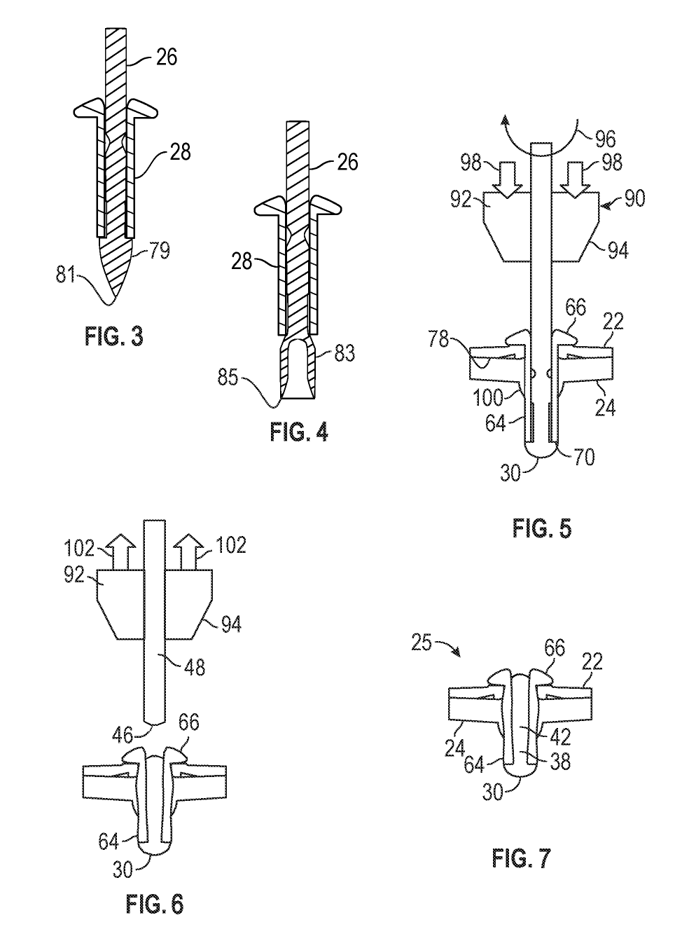

In various examples, the mandrel 26 has a head 30 with a rounded tip as shown in FIGS. 1 and 2. In other examples the mandrel head may have different shapes, such as to facilitate formation of an opening in the workpieces 22, 24. For example, the mandrel 26 may have a head with a sharp tip to more readily cut through the workpieces, where needed. As shown in FIG. 3, the mandrel 26 has a head 79 with a tip 81 that is pointed for easier penetration of the workpieces 22, 24. In another example as shown in FIG. 4, the mandrel 26 includes a head 83 with a tip 85 that includes a cavity opening through its leading end so that an annular wall is formed around the cavity. At the end of the annular wall, an annular cutting edge is provided at the leading end of the tip 85 to cut through the workpieces 22, 24. The heads 79, 83, with the tips 81, 85 may be used with the mandrel 26 where a sharp feature is desired to cut through the workpieces.

Referring again to FIG. 1, in various examples the workpieces 22, 24 are brought together and placed so that they overlap with a surface 82 of the workpiece 22 mating with a surface 84 of the workpiece 24. The mating surfaces 82, 84 may encompass only a part of the workpieces 22, 24, which may extend apart from one another in any direction. In some examples the workpieces 22, 24 may be spaced apart from one another or may comprise any number and type of workpieces. The workpieces 22, 24 are presented to the FSBR 20 without a pilot hole being prepared. Accordingly, no need exists to form or align holes through the workpieces 22 and 24. In a number of examples as shown in FIG. 5, a machine 90 may be used to secure the FSBR system 25. In the sectional illustration of FIG. 5, cross hatching is omitted for simplicity and clarity. The machine 90 includes clamps 92, 94 that contact the mandrel 26 at its outer perimeter 50, and that impart a rotational input 96 and a translational feed rate 98 directed toward the workpiece 22. The head 30 contacts the workpiece 22 wherein force and frictional heat between the head 30 and the workpieces 22, 24 resulting from the feed rate 98 and the rotational input 96 displaces material as the FSBR 20 is driven into the workpieces 22, 24. The feed rate 98 continues so that the head 66, and specifically the annular surface 78 contacts the workpiece 22. As a result, the body 64 of the shank 28 extends through the workpieces 22 and 24 with the end 70 and the head 30 of the mandrel 26 extending out of the workpiece 24 on an opposite side from the head 66 and the clamps 92, 94. Due to a friction-induced thermal effect and extrusion, material from the workpiece 24 is displaced by the FSBR 20 and gathers around the body 64 forming a wall 100 that encircles the body 64. The wall 100 is part of the workpieces 22 and/or 24 and extends toward the end 70 of the body 64. The wall 100 may fuse with the body 64 and rigidly retains the body 64 in position relative to the workpieces 22, 24.

When the friction stir action complete, the feed rate 98 and the rotational input 96 stop and as illustrated in FIG. 6, a pull-back force 102 is applied to the mandrel 62 by the clamps 92, 94 pulling away from the workpieces 22, 24. In the sectional illustration of FIG. 6, cross hatching is omitted for simplicity and clarity. The head 66 may be held against workpiece 22 while applying the pull-back force 102. As the mandrel tail section 48 is withdrawn, it breaks-off from the remainder of the mandrel 26 at the notch 47. Under application of the pull-back force, the head 30 is pulled back toward the workpiece 24 causing the body 64 of the shank 28 to deform or buckle locking the workpieces together as shown in FIG. 7. In the sectional illustration of FIG. 7, cross hatching is omitted for simplicity and clarity. The head 30, and the sections 38 and 42 of the mandrel 26 remain in place within the through-hole 68. It has been discovered that the properties of the wall 100 have an effect on the shear strength of the FSBR system 25. Specifically, if too large, the wall 100 blocks deformation of the body 64 of the shank 28 during the operation of pulling back the mandrel 26, which may lead to a suboptimal mechanical lock strength.

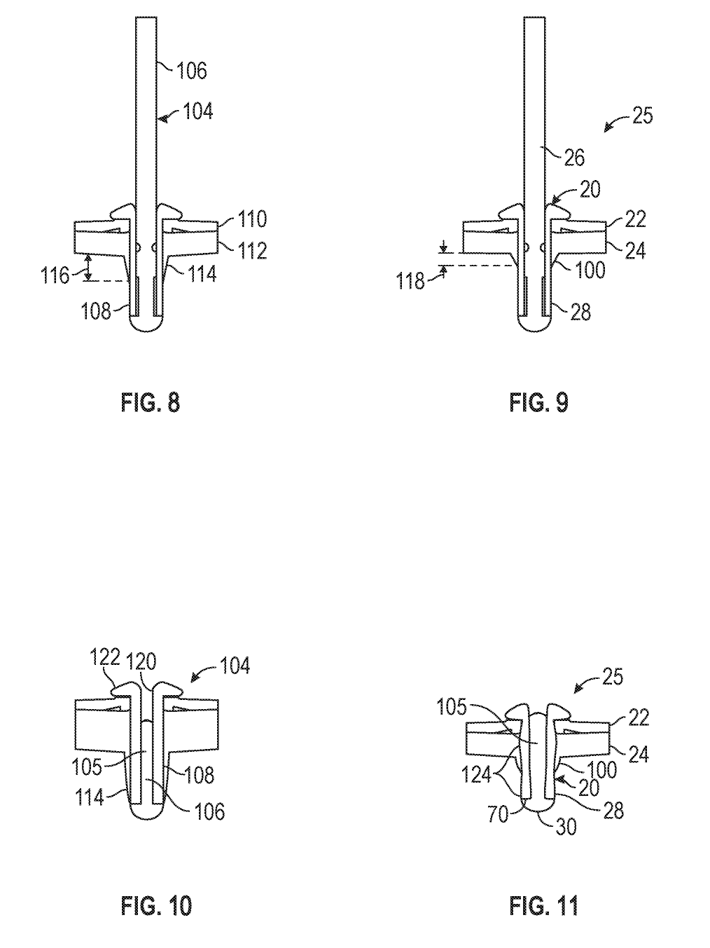

For purposes of description, reference is directed to FIG. 8 which shows a FSBR 104 with mandrel 106 and shank 108. In the sectional illustration of FIG. 8, cross hatching is omitted for simplicity and clarity. The FSBR 104 is shown having penetrated workpieces 110, 112. The penetration operation results in the flow of material from the workpieces 110, 112 as the FSBR 104 moves through, resulting in formation of a wall 114 encircling the shank 108. The wall 114 extends a distance 116 from the workpiece 112. Reference is directed to FIG. 9 where in comparison, the FSBR system 25 has formed the wall 100 which extends a distance 118 from the workpiece 24. In the sectional illustration of FIG. 9, cross hatching is omitted for simplicity and clarity. The distance 118 is less than the distance 116. In one specific example the distance 116 is 5.80 millimeters, and the distance 118 is 4.08 millimeters. With reference to FIG. 10, following application of the pull-back force 102 and break-off of the mandrel tail section of the FSBR 104 of FIG. 8, it can be seen that the wall 114 has blocked the shank 108 from deforming. In the sectional illustration of FIG. 10, cross hatching is omitted for simplicity and clarity. The shank 108 remains substantially straight and in the shape of a hollow cylinder. In addition, the retained part of the mandrel 104 is recessed within the through-hole 120 and is spaced away from the head 122. Reference is directed to FIG. 11 where in comparison, the FSBR 20 of FIG. 9 has the wall 100 where, following application of the pull-back force 102 and break-off of the mandrel tail section, the body 64 of the shank 28 has deformed in a buckled fashion. In the sectional illustration of FIG. 11, cross hatching is omitted for simplicity and clarity. More specifically, force applied to the end 70 by the head 30 during pull back has compressed the body 64 forming annular sections 124 that bulge outward away from the through-hole 68 and against the workpiece 24. The remainder of the mandrel 26 (retained mandrel 105), is recessed within the through-hole 68 substantially less than in the example of FIG. 10. This outcome has been found to result from the smaller wall 100, as compared to the wall 108.

Formation of the walls 100, 108 has been found to be controllable by varying the flowability of the sheet material of the workpieces 22, 24. This is accomplished through adjusting heat input according to the pseudo heat index (PHI) using the equation:

$$PHI = \frac{{ω}^{2}}{V 10000}$$

where ω is the mandrel rotational speed in revolutions per minute (RPM), and V is the feed rate of the mandrel in millimeters per second.

A PHI with higher heat input results in greater material flowability, and leads to more material forming a larger and longer wall. Therefore, lowering the PHI for lower heat input has been found to reduce the amount of material forming the wall 100 and the length 118 of the wall 100. This direct correlation between PHI and the size and length of the wall 100 provides the ability to control the size of the wall 100. Controlling the length of the wall 100 may be used to provide a preferred deformation of the shank 28, and greater strength of the installed FSBR system 25. The PHI may be lowered by decreasing the ω, or by increasing the V. For example, in the case of the FSBR 104 of FIG. 10, during processing to penetrate the workpieces 110 and 112, a PHI of 1600, a ω of 12,000 RPM, and a V of 9 mm/s were used. In the case of the FSBR 20 of FIG. 11, during processing to penetrate the workpieces 110 and 112, a PHI of 900, a ω of 9,000 RPM, and a V of 9 mm/s were used. Accordingly, a speed reduction of 3000 RPM results in a smaller/shorter wall 100 and the deformed shank 28 of the FSBR system 25 of FIG. 11 as compared to the outcome of FIG. 10.

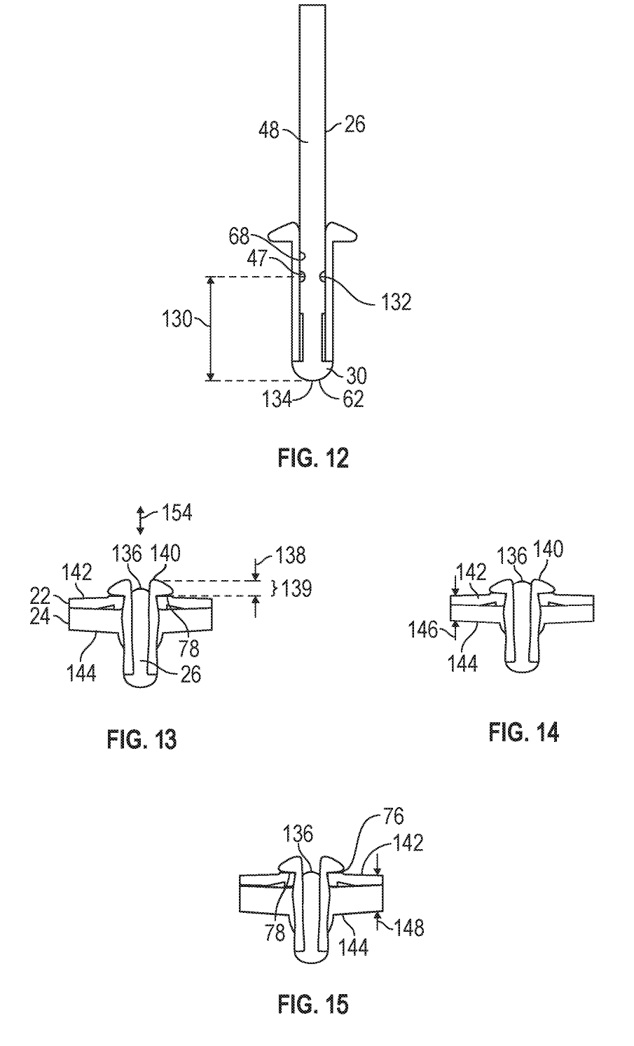

Returning to the distance that the retained mandrel 105 is recessed in the through-hole 68 following break-off of the tail section 48, reference is made to FIGS. 12 and 13. In the sectional illustrations of FIGS. 12 and 13, cross hatching is omitted for simplicity and clarity. The mandrel 26 includes the notch 47, which determines the break point between the tail section 48 and the retained mandrel 105 following break-off. The initial location of the notch 47 prior to break-off as shown in FIG. 12, places it within the shank 28 in the through-hole 68. For reference, location of the notch 47 may be expressed by a distance 130 from the center 132 (narrowest point), of the notch 47 to the tip 134 on the leading surface 62 of the head 30. The distance 130 may also be referred to a d_{notch}. The distance 130 is one factor in determining the location of the broken end 136 of the retained mandrel 105 relative to the shank 28. A reference for use in defining the location of the broken end 136 is the distance 138 from the outermost point 140 of the head 66 to the surface 78 of the shoulder 76, is referred to as d_{head}. The distance 138 may also be described as the thickness of the head 66 in an axial direction 154. It has been found that controlling the relative location of the notch 47 in the mandrel 26 (d_{notch}), optimizes the shear strength of the FSBR system 25. Specifically, d_{notch} is tuned to ensure the broken end 136 of the retained mandrel 105 is within a range 139 between the outermost point 140 of the head 66 of the shank 28 and the surface 78 of the shoulder 76. The range 139 includes any point within the distance d_{head}. Tuning places the broken end 136 outboard from the outer surface 142 of the workpiece 22. The effect is that the retained mandrel 105 extends completely through the workpieces 22 and 24.

With reference to FIGS. 14 and 15, the allowable thickness variation of the stack-up of the workpieces 22, 24 may be referred to as the grip range t of the FSBR 20. In the sectional illustrations of FIGS. 14 and 15, cross hatching is omitted for simplicity and clarity. The grip range t is the distance between the outer surface 142 of the workpiece 22 and the outer surface 144 of the workpiece 24. In the case of FIG. 14, a minimum stack-up 146 (lower limit of grip range t), places the broken end 136 at the same level as the outermost point 140 of the head 66. This ensures that the broken end 136 is within the range 139 and does not protrude beyond the head 66, which may otherwise create a catch point. The minimum stack-up 146 may be referred to as tₘᵢₙ. In the case of FIG. 15, the maximum stack-up 148 (upper limit of grip range t), places the broken end 136 at the same level as the surface 78 of the shoulder 76, which is against (at the same plane as), the outer surface 142 of the workpiece 22. This ensures that the broken end 136 is within the range 139 and is not recessed below (as viewed), the outer surface 142. The maximum stack-up 148 may be referred to as tₘᵢₙ+d_{head}. Accordingly, the grip range t may be expressed as:

tₘᵢₙ≤t≤tₘᵢₙ+d_{head}.

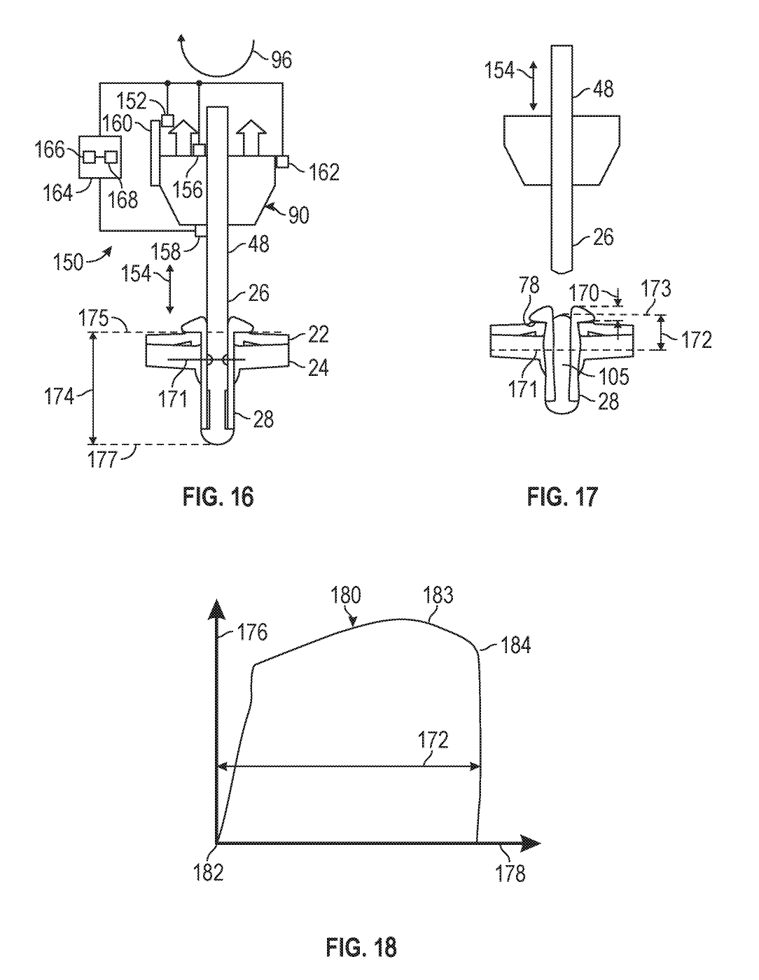

Having identified the location of the notch 47 as a factor in shear strength of the FSBR system 25, that factor may be leveraged to provide real-time monitoring of joint quality. With reference to FIGS. 16 and 17, the machine 90 is equipped with a control system 150. In the sectional illustrations of FIGS. 16 and 17, cross hatching is omitted for simplicity and clarity. An axial direction 154 is defined parallel to the length of the mandrel 26, and the direction toward and away from the workpieces 22, 24. A distance sensor 152 monitors the displacement of the clamps 92, 94 in the axial direction 154. For example, an eddy current, ultrasonic, optical or other sensor type may be used. A force sensor 156 monitors the load on the mandrel 26 in the axial direction 154. For example a pull/tensile force sensor may be used on the clamps 92, 94, In some embodiments a load cell may be employed when the machine 90 applies an opposite force against the head 66 of the shank 28, or a combination tensile and compressive load sensor may be used. A clamp actuator 158, which may be a linear actuator, is provided to contract and expand the clamps 92, 94 to grip or release the mandrel 26. A linear actuator 160 is provided to advance and withdraw the clamps 92, 94 and FSBR 20 in the axial direction 154 relative to the workpieces 22, 24, including to effect the translational feed rate 98. A rotary actuator 162 selectively drives the clamps 92, 94 and the FSBR 20, to provide the rotational input 96. The control system 150 includes an electronic controller 164. The electronic controller 164 includes at least one processor 166 and a computer readable storage device or media 168. The processor 166 performs the computation and control functions of the electronic controller 164, and may comprise any type of processor or multiple processors, single integrated circuits such as a microprocessor, or any suitable number of integrated circuit devices and/or circuit boards working in cooperation to accomplish the functions of a processing unit. During operation, the processor 166 executes one or more programs which may be contained within memory and, as such, controls the general operation of the electronic controller 164 and the computer system of the controller 164 in executing the processes described herein. The computer-readable storage device or media 168 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of represent executable instructions, used by the electronic controller 164 in controlling the machine 90. The instructions may include one or more separate programs, each of which comprises an ordered listing of executable instructions for implementing logical functions. The instructions, when executed by the processor 166, receive and process signals from the sensors 152, 156, perform logic, calculations, methods and/or algorithms for automatically controlling the machine 90. The processor 166 generates control signals for the actuators 158, 160, 162 to automatically control the components of the machine 90 based on logic, calculations, methods, and/or algorithms. It will be understood and appreciated that the electronic controller 164 will monitor the mandrel 26 displacement and axial force, and actuate the clamp actuator 158, the linear actuator 160 and the rotary actuator 162 during the conduct of the FSBR process, as further described below. In addition, the electronic controller 164 may perform any of a number of monitoring and control functions. For example the control system 150 via the electronic controller 164 may be set/reset with the process parameters or to process different thicknesses of workpiece material stackup. The control system 150 via the electronic controller 164 may monitor process parameters and provide outputs in the form of information, alarms, or otherwise.

With reference to FIGS. 16 and 17, an ongoing quality monitoring and diagnosis capability is provided. Specifically, the processor 166 calculates the location of the retained mandrel 105 in the joint following break-off of the tail section 48. The distance 170 between the broken end 136 of the retained mandrel 105 and the surface 78 of the shoulder 76 of the shank 28 (l_{mandrel-to-shank}), is determined by the calculation:

l_{mandrel-to-shank}=dₚᵤₗₗ(d_{feed}−d_{notch})

where:
dₚᵤₗₗ is the distance from an initial location 171 to an end location 173, that the mandrel 26 is pulled in the axial direction 154 during pull back and break-off of the tail section 48, and is indicated as pull-back displacement 172; and
d_{feed} is the distance that the mandrel 26 advances from first contacting the workpiece 22 at location 175 until completion of the penetration stroke at location 177, and is indicated as penetration displacement 174.

Referring additionally to FIG. 18, a graph of force/displacement of the clamps 92, 94 and the gripped mandrel 26 is illustrated with force on the vertical axis 176 versus displacement on the horizontal axis 178. The pull-back displacement 172 (dₚᵤₗₗ), is determined in a number of embodiments through the use of the curve 180. Prior to initiating pull-back of the clamps 92, 94, force and displacement are both zero at point 182. When pull-back is initiated, force rises as the mandrel 26 moves in the axial direction 154. The rate of change of force of the curve 180 decreases and prior to break-off of the tail section 48, force drops at segment 183. Upon break-off at point 184, the tail section 48 separates from the retained mandrel 105 and force drops vertically at a displacement along the horizontal axis 178 from the origin that defines dₚᵤₗₗ 172. The determination of d_{feed} is made by the electronic controller 164 monitoring the distance sensor 152 during a workpiece penetration stroke. The value for d_{notch} is known from the design of the FSBR 20, is programmed into the computer readable storage device or media 168, and is accessed by the processor 166 to perform the (l_{mandrel-to-shank}) calculation.

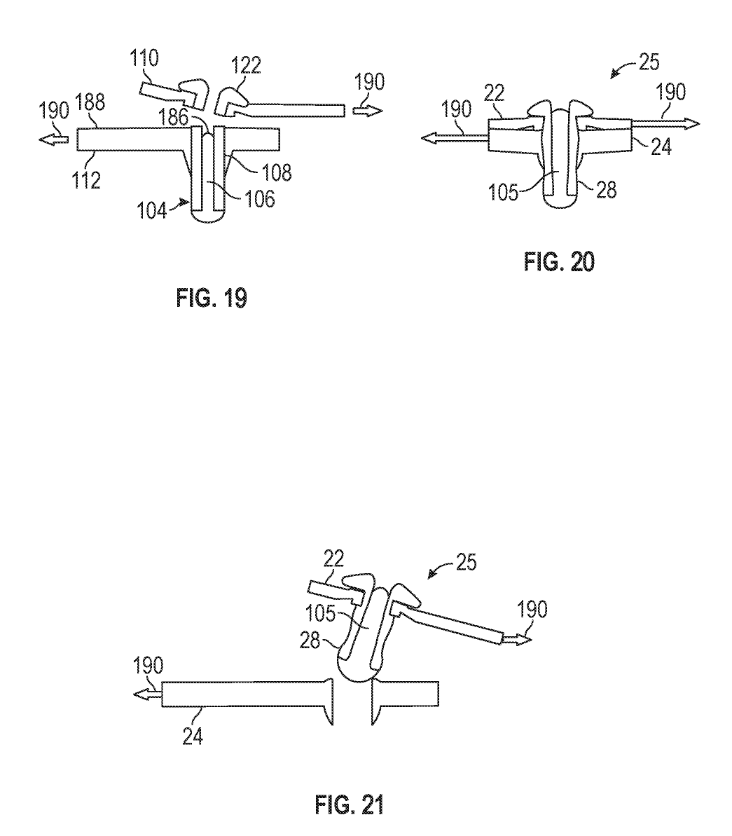

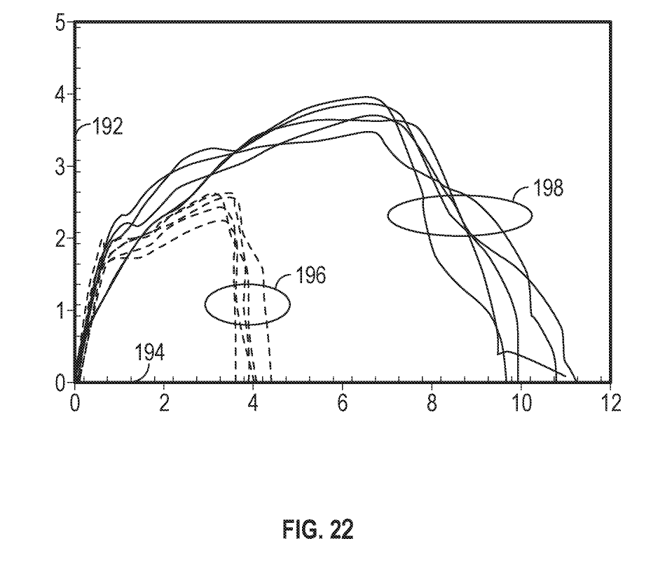

Referring to FIGS. 19-22, performance of the FSBR system 25 is demonstrated. In the sectional illustrations of FIGS. 19, 20 and 21, cross hatching is omitted for simplicity and clarity. In the case of FIG. 19, the FSBR 104 of FIG. 10 is shown with the retained part of the mandrel 106 recessed within the shank 108 so that its end 186 is below the surface 188 of the bottom workpiece 112. In other words, the retained part of the mandrel 106 is recessed so that it does not extend into the workpiece 110 or into the head 122 of the shank 108 and is outside the range 139. A lap-shear load 190 is applied to the workpieces 110 and 112 in opposite directions. As shown in FIG. 19, the fracture mode of the FSBR 104 joint entails shearing of the shank 108. With reference to FIG. 22, lap-shear tests results are shown with load in kilo-Newtons along the vertical axis 192 and displacement in millimeters along the horizontal axis 194. FIG. 22 graphically depicts the results of five examples of lap-shear testing for FSBR 104 type joints. The five examples are shown by curves 196. As can be seen for FSBR 104 type joints, the maximum load is in a range of approximately 2.2-2.6 kilo-Newtons, with shank shearing as shown in FIG. 19 resulting in each case. FIG. 20 shows the FSBR system 25 with the applied lap-shear load 190. FIG. 22 also graphically depicts the results of five examples of lap-shear testing for FSBR system 25 type joints. These five examples are shown by curves 198. As can be seen for FSBR system 25 type joints, the maximum load is in a range of approximately 3.5-4.0 kilo-Newtons. Shank shearing did not occur in the testing of FSBR system 25 type joints. Instead, the fracture mode entailed FSBR pullout type fracture as shown in FIG. 21. As can be seen from the curves 198 this pullout type of fracture results in load depletion over a significantly greater displacement as compared to the curves 196 for the FSBR 104 type joints. With the FSBR system 25 type joint, the retained mandrel 105 supports the shank 28 during lap-shear stresses. The mandrel's hardness/strength may be optimized to ensure the mandrel 26 has sufficient strength to support the shank 28 under lap-shear loading, so as to avoid shank shearing type fracture.

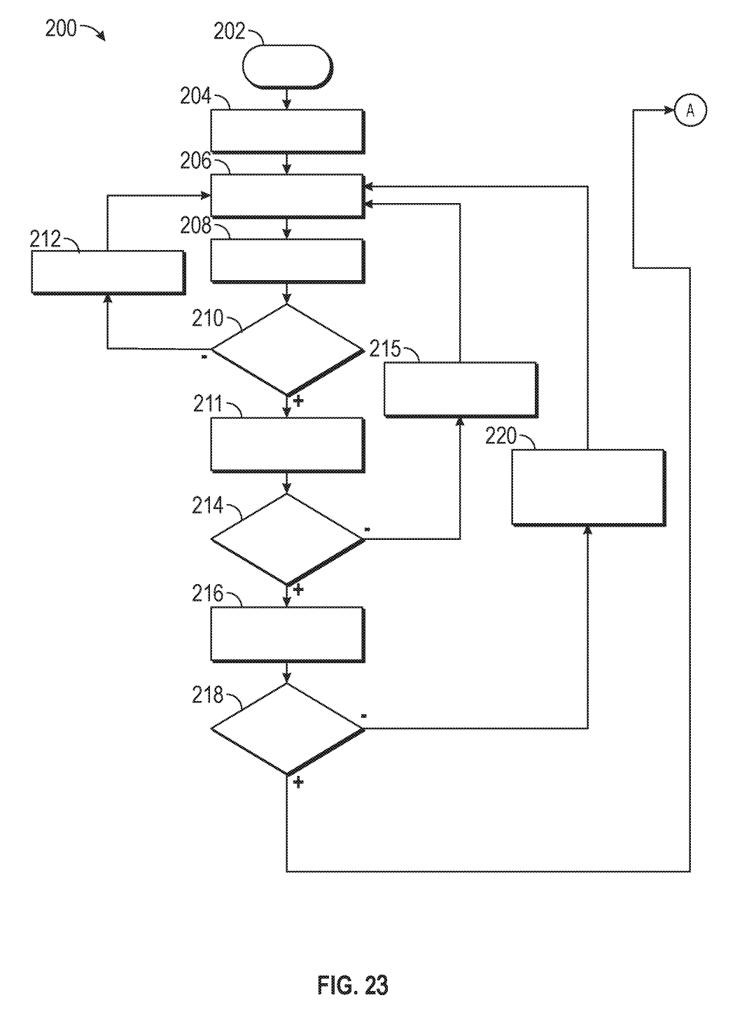

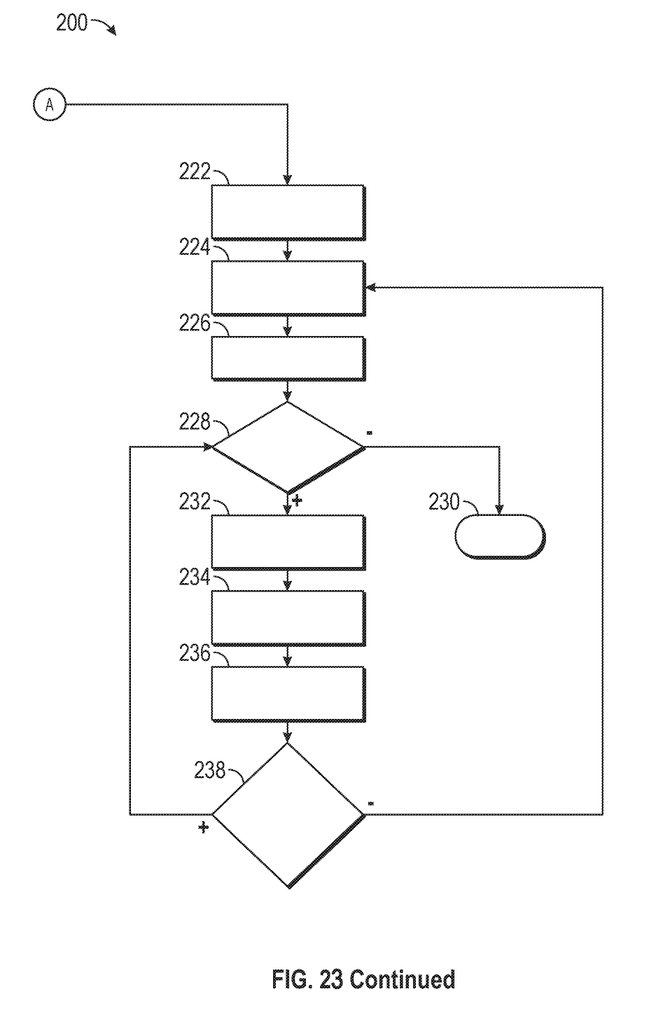

As depicted in FIG. 23, a FSBR joining process 200 for the FSBR system 25 includes an initiation or start step 202. For example, in various embodiments, the FSBR joining process 200 may be initiated when FSBR joining is needed. It should be appreciated that the process 200 may use data, information or products created prior to, or after, step 102. In addition, a number of steps of the process 200 may be initiated independently and/or may be carried out in advance of the commencement of a production setting FSBR joining of workpieces. Proceeding to step 204, values for the parameters of heat input (PHI), mandrel strength, and d_{notch} are selected. The values may be selected based on experience, modeling, or other approaches, to start the process of testing the selected parameters. The PHI parameter includes selecting the mandrel rotational speed ω and the feed rate and V. Moving to step 206, to test the heat input parameter, the FSBR 20 is applied to the workpieces 22, 24 such as through use of the machine 90 set with the parameters selected at step 204. Proceeding to step 208, pull-back is initiated by the machine 90 and the tail section 48 is broken from the retained mandrel 105. At step 210 a determination is made as to whether the wall 100 is formed such that acceptable deformation of the body 64 has occurred. For example, the determination may include identifying whether the formation of annular sections 124 from buckling has occurred. This may be determined from sectioning and inspecting the physical joint formed in steps 206-208. If the determination at step 210 is negative, meaning that the body 64 has not deformed, such as due to too large a wall 100, the process 200 proceeds to step 211 where the heat is adjusted. For example, the mandrel rotational speed ω may be lowered to reduce the size of the wall 100. The process 200 then returns to step 206 and steps 206-211 are repeated until a positive determination is made at step 210.

Following a positive determination at step 210, the process 200 proceeds to step 212 where checking the mandrel 26 strength parameter is initiated. For example, the FSBR joint produced at steps 206-208 may be subjected to lap-shear testing including fracture. Following fracture, the process 200 proceeds to step 214 where a determination is made as to whether the retained mandrel 105 has withstood the shear stress. For example, the fractured joint may be physically inspected to identify whether the retained mandrel 105 has withstood the shear stress. Where the determination is negative and the retained mandrel 105 has sheared, the process 200 proceeds to step 215 and the mandrel strength is increased, such as through selection of a mandrel 26 made of stronger material. From step 215, the process returns to step 206 and the process proceeds. Steps 206-215 may be repeated until a positive determination is made at step 214 and the mandrel 26 has not sheared. Step 214 also serves as a check on the overall FSBR system 25 such as by inspecting whether the fracture mode involved pull-out.

Following a positive determination at step 214, the process 200 proceeds to step 216 where checking the d_{notch} parameter is initiated. For example, the determination may be made manually, or automatically by the machine 90. The process 200 proceeds to step 218 where for example, the distance 130 may be evaluated for whether the broken end 136 of the retained mandrel 105 is within the range 139. The determination may be made by physically inspecting the formed joint. The determination may also be made by calculating l_{mandrel-to-shank} as described above. For example, the machine 90 may be used to perform the calculation during formation of the joint at steps 206-208. A calculation outcome of l_{mandrel-to-shank}<0 means that the broken end 136 of the retained mandrel 105 is excessively recessed into the through-hole 68 and the determination outcome is negative. Similarly, a calculation outcome of l_{mandrel-to-shank}>d_{head} means that the broken end 136 of the retained mandrel 105 protrudes from the through-hole 68 and the determination outcome is negative. When the determination at step 218 is negative, whether achieved manually or automatically, the process 200 proceeds to step 220 where the distance 130 is tuned to move d_{notch} within the range 139. For example, if the broken end 136 protrudes d_{notch} is reduced, and if the broken end 136 is excessively recessed, d_{notch} is increased. From step 220 the process 200 returns to step 206. Steps 206-220 may be repeated until a positive determination is made at step 218 and then the process 200 proceeds to step 222 where the values for the verified parameters are recorded, such as in the computer-readable storage device or media 168. It should be appreciated that determining the parameters of heat input (PHI), mandrel strength, and d_{notch} may be done in any order, may be conducted in parallel, and/or may be done in advance of a production environment. In addition, when testing one parameter through repeated negative determination loops, repetitive steps for the other parameters may be omitted.

The process 200 proceeds to step 224 where the machine 90 is set for a production run using the parameters recorded at step 222, and proceeding to step 226 the machine 90 is prepared to run. The process 200 proceeds to step 228 where a determination is made as to whether the machine 90 is to operate. For example, has the operator activated the start button. When the determination is negative at step 228, the process may end at step 230 and may be reinitiated at step 226 at any time. When the determination at step 228 is positive, the process 200 proceeds to step 232 and a FSBR 20 is applied to the workpieces 22, 24. The electronic controller 164 initiates a signal to the clamp actuator 158 to clamp onto the mandrel 26 and then to the linear actuator 160 to advance toward the workpiece 22. The electronic controller 164 signals the linear actuator 160 to advance the clamps 92, 94 at the feed rate V determined at steps 206-211 and recalled from the computer-readable storage device or media 168. The electronic controller 164 monitors the force sensor 156 and upon contact with the workpiece 22 as registered via a force increase, the electronic controller 164 initiates a signal to start the rotary actuator 162 at the rotational speed ω determined at steps 206-211 and recalled from the computer-readable storage device or media 168. In other examples, the electronic controller 164 initiates a signal to start the rotary actuator 162 when the mandrel 26 approaches the workpiece 22 as identified through the distance sensor 152. The process 200 proceeds to step 234 and the electronic controller monitors the distance sensor 152 and the force sensor 156. When, as indicated by an increase in force, the head 66, and specifically the surface 78, contacts the workpiece 22, the electronic controller 164 signals the linear actuator 160 to stop advancing and records the feed distance 174 in the computer-readable storage device or media 168 as a value for d_{feed}. The electronic controller 164 signals the rotary actuator 162 to stop. The electronic controller 164 signals the linear actuator 160 to pull back on the clamps 92, 94 and continues monitoring the distance sensor 152 and the force sensor 156. When breakoff of the tail section 48 occurs, the electronic controller records the pull-back displacement 172 in the computer-readable storage device or media 168 as a value for dₚᵤₗₗ.

Following break-off, the process 200 proceeds to step 236 where the processor 166 accesses the values for d_{feed} and dₚᵤₗₗ from the computer-readable storage device or media 168. The processor 166 calculates the value of l_{mandrel-to-shank} using the equation described above. The process 200 proceeds to step 238 where a determination is made as to whether the location of the retained mandrel 105 relative to the shank 28 is within the acceptable range 139. A calculation outcome of l_{mandrel-to-shank}<0 means that the broken end 136 of the retained mandrel 105 is excessively recessed into the through-hole 68 and the determination outcome is negative. Similarly, a calculation outcome of l_{mandrel-to-shank}>d_{head} means that the broken end 136 of the retained mandrel 105 protrudes from the through-hole 68 and the determination outcome is negative. When the determination at step 238 is negative, the process 200 proceeds to step 224 where the machine 90 and/or the FSBT 20 may be adjusted. Once the machine settings/process parameters are corrected, the process 200 may return to operation. At step 238, as long as the determinations are positive, meaning that quality parts are being produced, the process cycles through steps 228-238 until the production run is complete. For example, the operator of the machine 90 may activate the stop button and the process ends at step 230.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A friction stir blind rivet (FSBR) joining system for joining workpieces comprising:
a mandrel that has a first head forming a tip, with a stem extending from the first head, wherein the stem has a narrowed section forming a notch configured so that a tail section of the mandrel breaks-off, wherein the mandrel extends from the tip to a broken end;
a shank that has a second head and a body extending from the second head, with a through-hole defined through the shank including through the second head and the body, wherein the second head includes a shoulder forming a surface, with the surface contacting one of the workpieces, and the second head has an outermost point opposite the surface, wherein a range is defined between the outermost point of the second head and the surface; and
a wall projecting from another of the workpieces and formed around the body;
wherein the wall has a size formed by the mandrel and that is controlled to enable the body to deform.

2. The FSBR joining system of claim 1 wherein the size of the wall is controlled by use of the equation for pseudo heat index
$$( PHI ) = \frac{{ω}^{2}}{V 10000} ,$$
where ω is rotational speed of the mandrel and V is feed rate of the mandrel.

3. The FSBR joining system of claim 1 wherein the body is deformed by buckling to form annular sections that bulge outward against the workpieces.

4. The FSBR joining system of claim 1 wherein the notch is formed a distance d_{notch} from the tip so that the broken end is disposed in the range.

5. The FSBR joining system of claim 4 wherein the workpieces have a stack thickness that varies within a grip range defined by tₘᵢₙ≤t≤tₘᵢₙ+d_{head}, where t is the stack thickness of the workpieces together, tₘᵢₙ is the minimum allowable stack thickness, and d_{head} is a second distance that is defined from the outermost point of the second head to the surface.

6. The FSBR joining system of claim 1 wherein the location of the broken end is disposed at a location (l_{mandrel-to-shank}) that is defined by dₚᵤₗₗ−(d_{feed}−d_{notch}), where dₚᵤₗₗ is a first amount the mandrel is pulled to compress the shank, d_{feed} is a second amount the mandrel is fed into the workpieces, and d_{notch} is a distance from the tip to the notch.

7. The FSBR joining system of claim 1 wherein the wall encircles the body and rigidly retains the body in position.

8. The FSBR joining system of claim 1 wherein the mandrel, when extending only from the tip to the broken end, extends completely through both the workpieces.

9. A friction stir blind rivet (FSBR) joining method comprising:
providing a FSBR that includes a mandrel that has a tip and a notch;
extending the mandrel through a shank that has a head with an outermost point and a surface opposite the outermost point;
determining parameters that include a mandrel rotational speed (ω), a feed rate (V), a mandrel strength, and a distance d_{notch} from the tip to the notch;
setting a machine to operate using the parameters;
operating the machine to apply the FSBR to a workpiece; and
operating the machine to pull back on the mandrel to break a tail section from the mandrel so that the mandrel extends from the tip to the broken end and so that the broken end is disposed within the head.

10. The method of claim 9 wherein determining the parameters comprises testing the mandrel rotational speed (ω) and the feed rate (V) by:
applying, by the machine, the mandrel to penetrate first and second workpieces;
pulling-back, by the machine, the mandrel;
breaking-off, by the machine, a tail section of the mandrel;
determining whether deformation of the body has occurred with formation of annular sections from buckling; and
when the determination is deformation has not occurred, adjusting a pseudo heat index by decreasing the ω and/or increasing the V imparted by the machine.

11. The method of claim 9 wherein determining the parameters comprises testing the mandrel strength by:
subjecting the FSBR to a lap-shear test including fracture;
determining whether the mandrel has sheared; and
when the determination finds the mandrel has sheared, increasing strength of the mandrel.

12. The method of claim 9 wherein determining the parameters comprises testing the distance d_{notch} by:
defining a range for acceptable locations of the broken end as between the outermost point of the head and the surface of the head; and
evaluating the distance d_{notch} to determine whether the broken end is within the range by calculating, by a processor, l_{mandrel-to-shank}, wherein l_{mandrel-to-shank}=dₚᵤₗₗ−(d_{feed}−d_{notch}), where dₚᵤₗₗ is a distance the mandrel is pulled to compress the shank, d_{feed} is a distance the mandrel is fed to penetrate workpieces, and d_{notch} is a distance from the tip to the notch.

13. The method of claim 12 further comprising:
when the calculation result is l_{mandrel-to-shank}<0, increasing d_{notch} to move the broken end within the range.

14. The method of claim 12 comprising:
when the calculation result is l_{mandrel-to-shank}>d_{head}, reducing d_{notch} to move the broken end within the range.

15. The method of claim 9 comprising:
signaling, by an electronic controller, a clamp actuator to clamp onto the mandrel;
signaling, by the electronic controller, a linear actuator to advance the mandrel toward a workpiece;
monitoring, by the electronic controller, a force sensor;
when the force sensor registers a force increase indicative of mandrel contact with the workpiece, signaling, by the electronic controller, a rotary actuator to operate at the mandrel rotational speed ω;
signaling the linear actuator to advance the mandrel at the feed rate V;
monitoring, by the electronic controller, a distance sensor and the force sensor;
when, as indicated by an increase in force sensed by the force sensor, the head of the shank contacts the workpiece, signaling, by the electronic controller, the linear actuator to stop advancing;
recording displacement of the linear actuator while advancing the mandrel as a feed distance value d_{feed} in a computer-readable storage device or media of the electronic controller;
signaling, by the electronic controller, the linear actuator to pull back on mandrel;
monitoring, by the electronic controller, the distance sensor and the force sensor while pulling back on the mandrel; and
when a break-off of the tail section occurs, recording in the computer-readable storage device or media a pull-back displacement of the mandrel as a value for dₚᵤₗₗ.

16. The method of claim 15 comprising
following the break-off, recalling, by the processor, the values for d_{feed} and dₚᵤₗₗ from the computer-readable storage device or media;
calculating, by the processor, a value of l_{mandrel-to-shank}. wherein l_{mandrel-to-shank}=dₚᵤₗₗ−(d_{feed}−d_{notch}), where d_{notch} is a distance from the tip to the notch;
defining d_{head} as a distance from the outermost point of the head to the surface; and
when the calculation results in 0≤l_{mandrel-to-shank}≤d_{head}, continuing to operate the machine.

17. A friction stir blind rivet (FSBR) joining system for joining first and second workpieces together comprising:
a mandrel that has a first head forming a tip, with a stem extending from the head, wherein the stem has a narrowed section forming a notch configured so that a tail section of the mandrel breaks-off at the notch when exposed to a tensile load, wherein the mandrel extends from the tip to a broken end following break-off;
a shank that has a second head and a body extending from the second head, with a through-hole defined through the shank, including through the head and the body, wherein the second head includes a shoulder forming a surface, with the surface contacting the first workpiece, and the head has an outermost point opposite the surface that is a part of the head farthest from the first workpiece, wherein a range is defined between the outermost point of the head and the surface as d_{head}; and
a wall projecting from the second workpiece and formed around the body, the wall formed when the mandrel and shank penetrate the workpieces;
wherein the wall has a size formed by interaction with the mandrel and the shank, wherein the size is controlled by a rotational speed at which the mandrel is rotated; and
wherein the size is controlled to enable the body to deform when the first head is forced against the body by pulling on the mandrel.

18. The FSBR joining system of claim 17 wherein the body forms annular sections that bulge outward as a result of deformation by buckling when the first head is forced against the body.

19. The FSBR joining system of claim 17 wherein the notch is formed a distance d_{notch} from the tip so that the broken end is disposed in the range and the mandrel extends completely through both the first workpiece and the second workpiece.

20. The FSBR joining system of claim 19 wherein the mandrel is positioned relative to the shank as defined by l_{mandrel-to-shank}, wherein:
l_{mandrel-to-shank}=dₚᵤₗₗ−(d_{feed}−d_{notch}),
where:
dₚᵤₗₗ is a distance the mandrel is pulled to compress the shank,
d_{feed} is a distance the mandrel is fed to penetrate workpieces, and
d_{notch} is a distance from the tip to the notch.
